(19) United States
(12) Patent Application Publication
(10) Pub. No.: US 2004/0244519 A1
(43) Pub. Date: Dec. 9, 2004

(54) Ball screw device

(76) Inventors: Daisaku Kawata, Gunma (JP); Minao Umeda, Gunma (JP)

Correspondence Address: SUGHRUE MION, PLLC, 2100 PENNSYLVANIA AVENUE, N.W., SUITE 800, WASHINGTON, DC, 20037, US

(21) Appl. No.: 10/493,397

(22) PCT Filed: Oct. 23, 2002
(86) PCT No.: PCT/JP02/10988

(30) Foreign Application Priority Data
Oct. 29, 2001 (JP) 2001-330225
Feb. 8, 2002 (JP) 2002-31766

(51) Int. Cl. F16H 25/22

(52) U.S. Cl. 74/424.82; 74/89.23

(57) ABSTRACT

The invention provides a ball screw device having high strength against a repetitive load and improved durability, which is assembled in an electric actuator, by absorbing a bending force by a simple method and making loads in the axial direction uniformly act on balls constructing the ball screw device. In the ball screw device, a ball nut is slid in the axial direction by rotation of a ball screw shaft to convert rotational motion of a motor to linear motion. An outer peripheral surface of the ball screw shaft and an inner peripheral surface of the ball nut are made in contact with each other, balls are disposed between the ball screw shaft and the ball nut, and openings at both ends of a circulating tube for circulating the balls in the device are disposed so as to be off from heavy load regions in which a load heavier than loads in other portions among loads acting on the balls is applied, thereby absorbing a bending force applied to the ball screw device.

### TECHNICAL FIELD

The present invention relates to a ball screw device for an actuator and, for example, to a ball screw device assembled in an electric actuator as for automatic control of an electrically-operated disc brake, a transmission, and the like, and used for converting rotational motion of an electric motor or the like to linear motion.

### BACKGROUND ART

In recent years, in the car industry, from the viewpoints of energy saving, environmental protection, safety, comfort, and the like, a process by computer is employed for various controls. In this case, a control signal used for the process by computer controls driving of an electric actuator in order to make parts of a car, such as a transmission, an electrically-operated disc brake, and the like, optimally drive.

An electrically-operated actuator of this kind constructed by, generally, combination of rotation of a motor and a screw is wide spread. As screws for an electrically-operated actuator, a sliding screw and a ball screw are known. Since devices and parts for a car are generally required to have small size and to be compact, a ball screw which can be driven by a motor of small output with high efficiency is employed for an electric actuator.

As such an electric actuator, for example, an actuator provided in a transmission case, disclosed in International Publication No. W001/31234A1, is used. A switching shaft is displaced in the axial direction or rotated by the actuator, thereby changing the transmission gear ratio of a transmission unit. In the transmission unit, by the driving of the actuator, a ball screw shaft is rotated and a ball nut is displaced in the axial direction. Due to engagement between a coupling pin of an output member coupled to the ball nut and a long hole formed in a driver arm, the drive arm swings, thereby performing a shifting operation.

When the drive arm swings in the shifting operation, a relatively large moment acts orthogonally to the axial direction onto the ball nut by a reaction force from the coupling pin. The moment directly acts on the ball nut. The direction of the moment is unchanged even when the drive arm is displaced in any of directions. On the other hand, in the case of canceling the shifted state, a moment in the opposite direction acts on the ball nut but the moment is small.

When a force of pressing the coupling pin to the outer side acts by the actuator in the shifting operation, a reaction force is generated in the coupling pin, a force in the bending direction acts on the ball nut with respect to the ball screw shaft, and a relative displacement occurs between the ball screw shaft and the ball nut. It causes a situation such that a concentrated load in the axial direction is generated in a ball in the ball screw and durability of the ball screw deteriorates. In some cases, a load generated by bending becomes excessive on balls positioned at both ends of the ball nut among a series of balls disposed between the ball screw shaft and the ball nut as compared with loads on the balls positioned on the center side.

A heavy load due to the moment acts in predetermined angle ranges α1 and α2 in the circumferential direction of the ball nut (refer to FIG. 7) and predetermined ranges β1 and β2 (refer to FIG. 8) at ends on the moment acting direction side in the axial direction. Therefore, portions where the ranges α1 and α2 with respect to the circumferential direction and the ranges β1 and β2 with respect to the axial direction coincide each other become heavy load regions in which a heavy load based on the moment M acts.

In openings at both ends of a circulating tube, balls are received and transmitted. Consequently, the number of balls in the openings always changes, and it is feared that the number of balls which can be actually supported is reduced. When the openings at both ends are in the heavy load regions, excessive surface pressure tends to act on the balls, the stress is concentrated, wear and breakage occurs in the parts of the ball screw, and durability deteriorates.

In consideration of such circumstances, an object of the invention is to supply at lower expenses a ball screw device having high strength against a repetitive load and improved durability, which is assembled in an electric actuator, by absorbing a bending force by a simple method and making loads in the axial direction uniformly act on balls constructing the ball screw device.

### DISCLOSURE OF THE INVENTION

A ball screw device according to a first mode of the invention includes: a ball screw shaft; a ball nut which screws on the ball screw shaft; and a plurality of balls rotatably provided in a spiral passage formed by an outer peripheral groove of the ball screw shaft and an inner peripheral groove of the ball nut. Rotational motion of a motor is converted to linear motion by sliding the ball screw shaft and the ball nut in the axial direction by relative rotation between the ball screw shaft and the ball nut. The ball screw device is characterized in that a contact surface is provided in an outer peripheral surface of the ball screw shaft and a contact surface is provided in an inner peripheral surface of the ball nut, which are in contact with each other.

According to a second mode of the invention, the ball screw device according to the first mode is characterized in that the contact surfaces are provided at least at one of both ends of the spiral passage and provided as opposite surfaces of the outer peripheral surface of the ball screw shaft and the inner peripheral surface of the ball nut.

Therefore, based on the first and second modes, the outer peripheral surface of the ball screw shaft and the inner peripheral surface of the ball nut are in close contact with each other, and uniform loads act on the balls moving in the spiral passage.

A ball screw device according to a third mode of the invention includes: a ball screw shaft; a ball nut which screws on the ball screw shaft; a plurality of balls rotatably provided in a spiral passage formed by an outer peripheral groove of the ball screw shaft and an inner peripheral groove of the ball nut; and a circulating tube in which the balls moving in the spiral passage are circulated. A contact surface is provided in an outer peripheral surface of the ball screw shaft and a contact surface is provided in an inner peripheral surface of the ball nut, which are in contact with each other. Rotational motion of a motor is converted to linear motion by sliding the ball screw shaft and the ball nut in the axial direction by rotation of the ball screw shaft. The ball screw device is characterized in that openings at both ends of the circulating tube are disposed in positions which are not in regions of heavy loads among loads acting on a plurality of balls fit in the spiral passage, and the balls are transmitted/received in a connection position between the circulating tube and the spiral passage.

Therefore, based on the third mode, an excessive load can be prevented from being applied on the balls positioned in the connection positions between the circulating tube and the spiral passage, that is, in openings at both ends of the circulating tube.

According to a fourth mode of the invention, in the ball screw device according to the third mode, the contact surface is at least at one of both ends of the spiral passage and is provided as opposite surfaces of the outer peripheral surface of the ball screw shaft and the inner peripheral surface of the ball nut.

Consequently, according to the fourth mode, the outer peripheral surface of the ball screw shaft and the inner peripheral surface of the ball nut are in close contact with each other, and uniform loads act on the balls moving in the spiral passage.

According to a fifth mode of the invention, in the ball screw device according to any one of the first to fourth modes, the contact surface is made of an intermediate member having a coefficient of friction lower than that of a ball screw shaft material and that of a ball nut material.

According to a sixth mode of the invention, in the ball screw device according to any one of the first to fourth modes, the contact surface is made of an elastic member.

Thus, according to the fifth and sixth modes, a bending force generated in balls constructing the ball screw device or the like can be absorbed by the intermediate member having a low coefficient of friction or the elastic member.

A ball screw device according to a seventh mode of the invention includes: a ball screw shaft; a ball nut which screws on the ball screw shaft; and a plurality of balls rotatably provided in a spiral passage formed by an outer peripheral groove of the ball screw shaft and an inner peripheral groove of the ball nut: Rotational motion of a motor is converted to linear motion by sliding the ball screw shaft and the ball nut in the axial direction by rotation of the ball screw shaft. The ball screw device is characterized in that openings at both ends of the circulating tube are disposed in positions which do not become regions of heavy loads among loads acting on a plurality of balls which are fit in the spiral passage, and the balls are transmitted/received in a connection position between the circulating tube and the spiral passage.

Therefore, based on the seventh mode, application of an excessive load on the balls in the connection positions between the circulating tube and the spiral passage, that is, in the openings at both ends of the circulating tube can be prevented.

### BRIEF DESCRIPTION OF THE DRAWINGS

FIG. 1 is a plan view showing the configuration in which an actuator having a ball screw according to the invention is applied to a transmission for a vehicle;

FIG. 2 is a cross section taken along line Z-Z of FIG. 1;

FIG. 3 is a partially cutaway plan view of an actuator having a ball screw device according to a first embodiment of the invention;

FIG. 4 is a diagram showing a second embodiment;

FIG. 5 is a diagram showing a third embodiment;

FIG. 6 is an explanatory diagram illustrating a state where the actuator drives in an A direction;

FIG. 7 is a cross section taken along line A-A of FIG. 3;

FIG. 8 is a cross section taken along line B-B of Fig.

FIG. 9 is a partially cutaway plan view of an actuator having a ball screw device according to a fourth embodiment;

FIG. 10 is a cross section taken along line C-C of FIG. 9;

FIG. 11 is a cross section taken along line D-D of FIG. 10;

FIG. 12 is a partially cutaway plan view of an actuator having a ball screw device according to a fifth embodiment;

FIG. 13 is a cross section taken along line E-E of FIG. 12;

FIG. 14 is a cross section taken along line F-F of FIG. 13;

FIG. 15 is a partially cutaway plan view of an actuator having a ball screw device according to a sixth embodiment;

FIG. 16 is a cross section taken along line G-G of FIG. 15; and

FIG. 17 is a cross section taken along line H-H of FIG. 16.

### BEST MODE FOR CARRYING OUT THE INVENTION

Embodiments of the invention will be described hereinbelow with reference to the drawings.

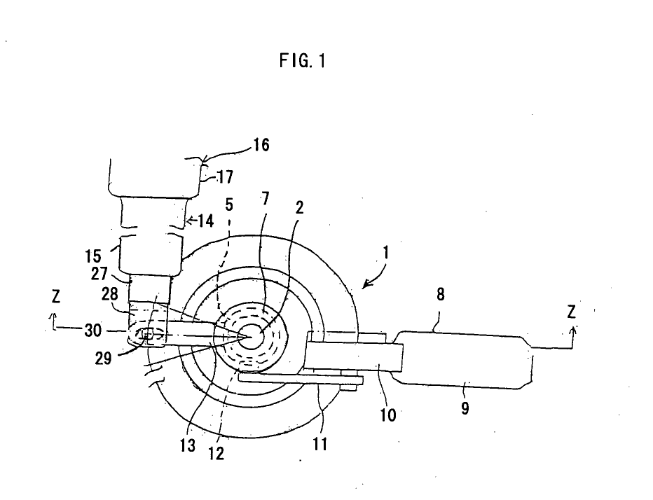

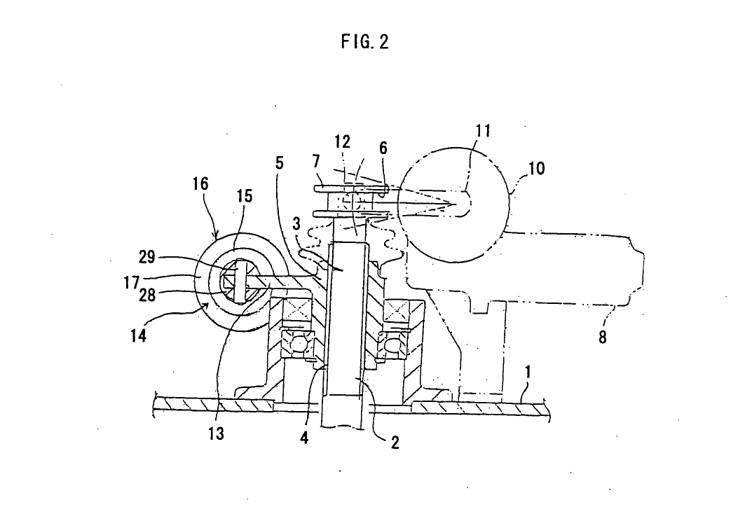

FIGS. 1 and 2 show an example of applying a ball screw device according to a first embodiment of the invention to a transmission for a vehicle. In the drawings, a tip portion 3 of a switching shaft 2 for switching a transmission gear ratio is projected from a side surface of a transmission case 1. A male spline 4 is formed in some mid point of the tip portion 3 and is spline-fit in a spline cylinder 5. A female spline is formed in the inner surface of the spline cylinder 5. To the portion projected from the spline cylinder 5 of the tip portion 3, an engage piece 7 in which an engagement groove 6 is formed is coupled.

The switching shaft 2 performs a selecting operation by being displaced in the axial direction and performs a shifting operation by rotating. The selecting operation is an operation of selecting a gear for speed change by displacing a shift lever in a general manual floor-mounted gearshift car in the width direction of the car. The shifting operation is an operation of coupling a synchromesh mechanism corresponding to the selected gear by displacing the shift lever in the longitudinal direction of the car.

To perform the selecting operation, a first actuator 8 is provided. The first actuator 8 rotates a swing arm 11 via a worm wheel 10 by rotation of a first electric motor 9. An engagement projection 12 is formed at the tip of the swing arm 11. By engagement of the engagement piece 7 with the engagement groove 6, the switching shaft 2 is made displaceable in the axial direction.

To perform the shifting operation, a second actuator 14 in which the ball screw device as an object of the invention is assembled is provided between the transmission case 1 and a drive arm 13 provided on the peripheral surface of the spline cylinder 5. For the second actuator 14, a second electric motor 16 which can rotate both forward and reverse is fixed to an end of a housing 15 having an almost cylindrical shape via a motor housing 17 having a stepped cylindrical shape.

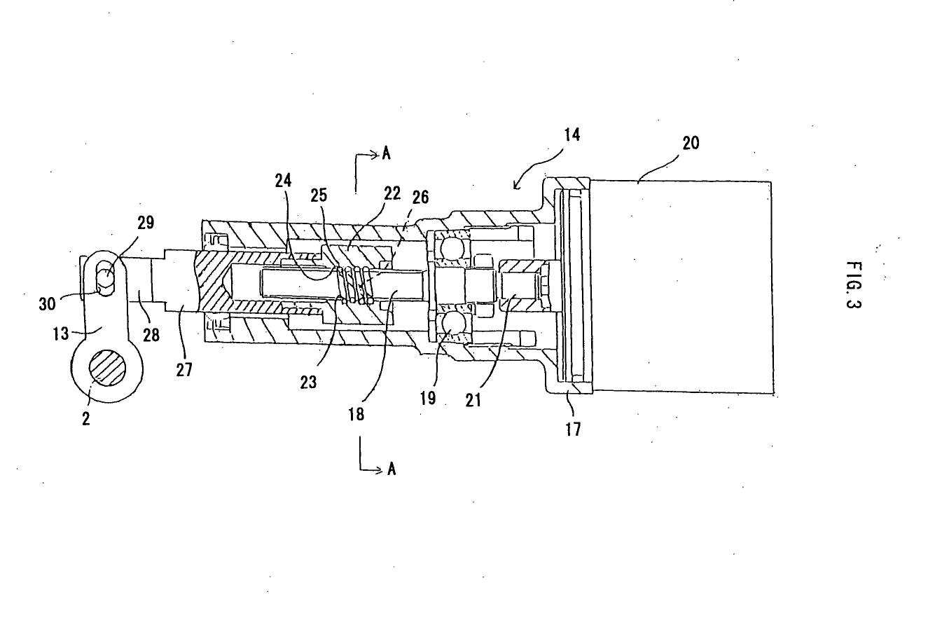

As shown in FIG. 3, a ball screw shaft 18 is rotatably supported by a rolling bearing 19 on the inside of the motor housing 17. The base portion of the base screw shaft 18 is coupled to an output shaft 21 of a second electric motor 20 so that rotational force of the second electric motor 20 is transmitted. A ball nut 22 is disposed around the ball screw shaft 18. A spiral passage is formed between a male ball screw groove 23 formed in the outer circumferential surface of the ball screw shaft 18 and a female ball screw groove 24 formed in the inner circumferential surface of the ball nut 22, and a plurality of balls 25 are disposed in the spiral passage. An annular tube 26 connecting both ends of the spiral passage is formed in the ball nut 22, and the balls 25 circulate in the spiral passage and the annular tube 26.

An output member 27 is integrally coupled to the ball nut 22. By displacing the ball nut 22 in the axial direction in association with rotation of the ball screw shaft 18, the output member 27 is displaced in the axial direction. Rotation of the ball nut 22 is regulated by a not-shown guide pin or the like. The ball nut 22 can move only in the axial direction.

It is designed so that the outer diameter of the ball screw shaft 18 is equal to the inner diameter of the ball nut 22 in a portion except for an insertion portion of the balls 25 (the spiral passage) between the ball screw shaft 18 and the ball nut 22, so that both the ball screw shaft 18 and the ball nut 22 are in close contact with each other. With the configuration, rigidity of the ball screw mechanism formed by the ball screw shaft 18 and the ball nut 22 is increased. Even if a moment acts on the ball nut 22, a relative displacement does not occur between the ball screw shaft 18 and the ball nut 22. Therefore, strength against bending increases, and durability improves.

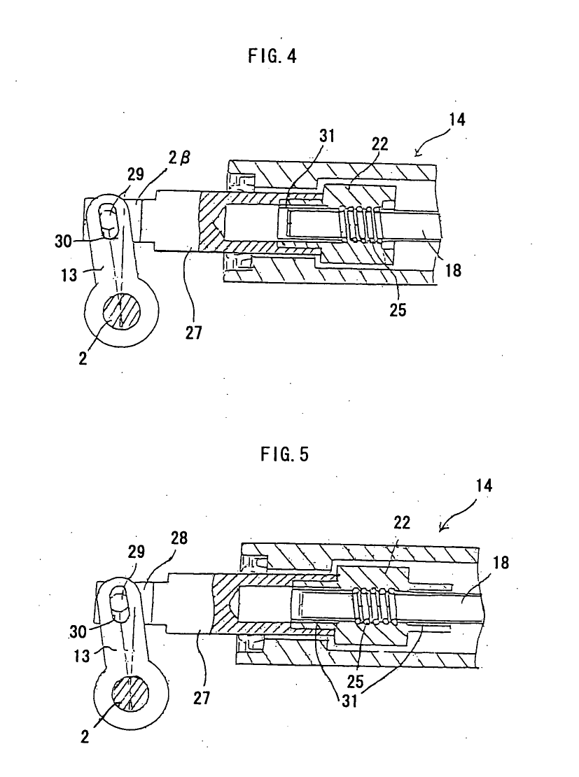

FIG. 4 shows a second embodiment in which an annular bush member 31 having elasticity is attached on the outer side of the insertion portion of the ball 25, that is, on the side of the output member 27 out of the both ends of the spiral passage between the ball screw shaft 18 and the ball nut 22 and in opposing surfaces of the ball screw shaft 18 and the ball nut 22. As the bush member 31, for example, a member having excellent heat resistance and a low coefficient of friction such as silicon or tetrafluoroethylene is used. Specifically, the bush member 31 disposed on the connection surfaces between the ball screw shaft 18 and the ball nut 22 is constructed by an intermediate member having a coefficient of friction lower than that of the ball screw shaft member and the ball nut material. With the configuration, a bending force generated in the ball screw mechanism can be absorbed more.

FIG. 5 shows a third embodiment in which the bush member 31 is attached to the insertion portion of the balls 25, that is, on both sides of the spiral passage between the ball screw shaft 18 and the ball nut 22. With the configuration, the bending force generated in the ball screw device can be absorbed more.

A coupling bracket 28 is attached to the tip of the output member 27, and a coupling pin 29 extends outward from an end of the coupling bracket 28. A long hole 30 which is long in the radial direction of the switching shaft 2 is formed in the tip of the drive arm 13. By engagement with the coupling pin 29, the drive arm 13 is swingably coupled.

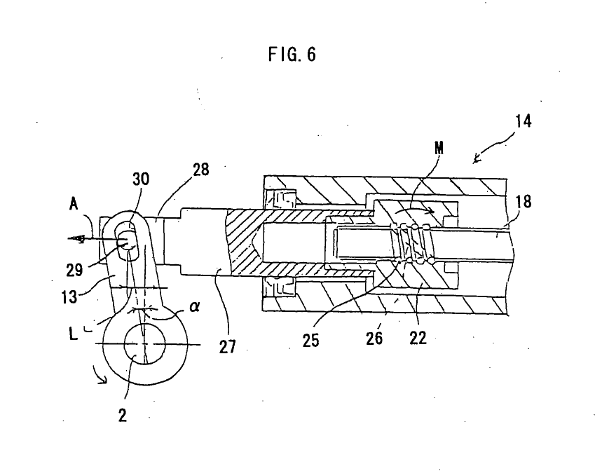

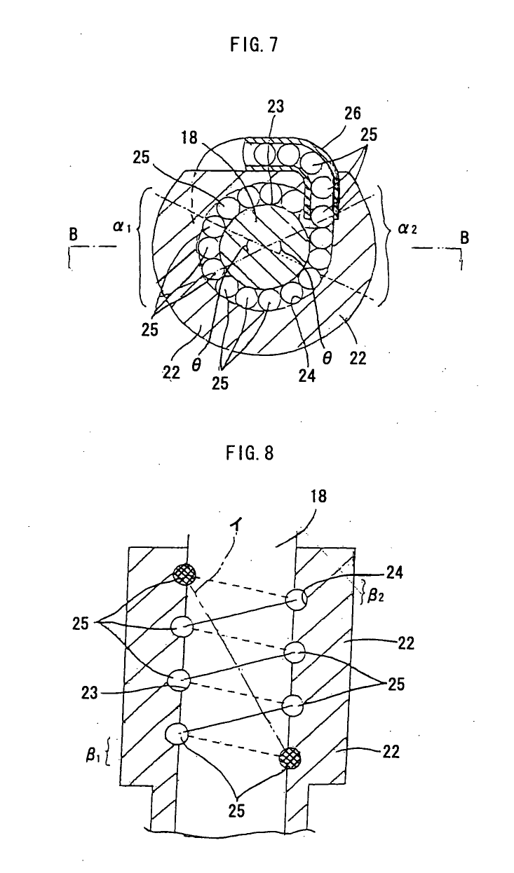

When the second actuator 14 drives, as shown in FIG. 6, for example, a pressing force in the A direction acts on the drive arm 13, the output member 27 moves only by a distance L in the axial direction and, by engagement between the coupling pin 29 and the long hole 30, the drive arm 13 is displaced only by an angle α. At this time, a reaction force based on kinetic energy is generated in the coupling pin 29 and a bending force by the movement M is generated in the direction of the arrow of FIG. 6. A heavy load region based on the moment M enters a state in which a heavy load can be applied in the angle ranges of α1 and α2 by the moment M with respect to the circumferential direction shown in the cross section of FIG. 7. With respect to the axial direction shown in the cross section of FIG. 8, a heavy load can be applied by the moment M in ranges of β1 and β2 in both end portions on the action direction side.

The angle θ of regulating the angle ranges α1 and α2 in the circumferential direction with respect to the heavy load region is, to be strict, about 60 degrees (±30 degrees from the action direction of the moment load) or, more widely (in consideration of safety factor), about 90 degrees (similarly, ±45 degrees). In other words, each of the openings at both ends of the circulating tube 26 is set to a range of the remaining angle of 300 to 270 degrees, which is the range other than the angle range in the end portion in the axial direction.

As a result, the portions in which the ranges α1 and α2 with respect to the circumferential direction and the ranges β1 and β2 with respect to the axial direction coincide with each other, specifically, a portion of α1 and β1 (α1*β2 portion) and a portion of α2 and β2 (α2*β2 portion) become heavy load regions to which a heavy load is applied based on the moment M. Consequently, openings at the both ends of the circulating tube 26 are provided on the side opposite to the heavy load regions with respect to the axial and circumferential directions of the ball nut 22.

The openings at both ends of the circulating tube 26 are disposed in positions which do not become regions of the heavy load among loads acting on the plurality of balls 25, 25, . . . which are fit in the spiral passage, and the balls 25 are transmitted/received in the connection positions between the circulating tube 26 and the spiral passage.

The circulating tube 26 is disposed, as shown in FIG. 8, in the direction shown by a chain line (a), and the openings at both ends of the circulating tube 26 exist in the portions corresponding to the double-hatched balls 25 out of the plurality of balls 25 and are disposed in portions off from the heavy load regions. With the configuration, the both ends of the circulating tube 26 are disposed so as to be off from the heavy load regions. The balls 25 are not received/transmitted in the heavy load region. In the heavy load region, the plurality of balls 25 always exist stably. On the other hand, the portion on the side opposite to the heavy load region by 180 degrees is a no-load region or a low-load region in which a load is hardly applied or a low load is applied. In this case, both ends of the circulating tube 26 are provided so as to be in the no-load region or low-load region.

Therefore, in the shifting operation, irrespective of the moment M acting on the ball nut 22, an excessive load can be prevented from being applied to a rolling contact portion between each of the balls 25 and the male and female ball screw grooves 23 and 24. Therefore, improvement in durability of the whole ball screw device such as improvement in rolling contact fatigue life of each of the surfaces constructing the rolling contact portion can be achieved.

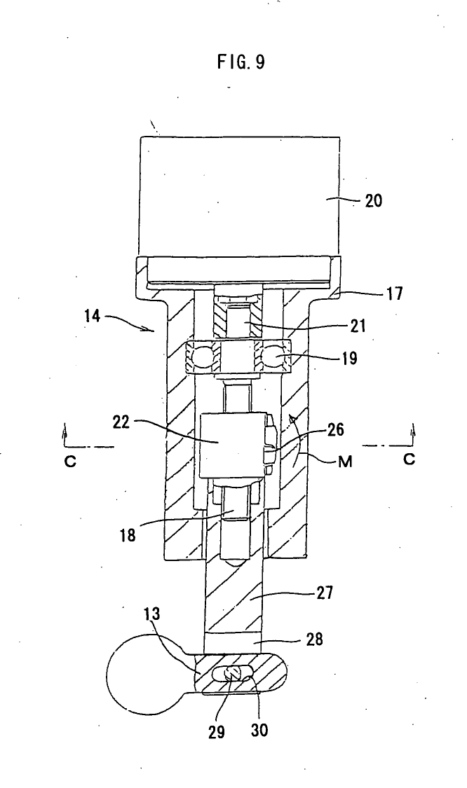

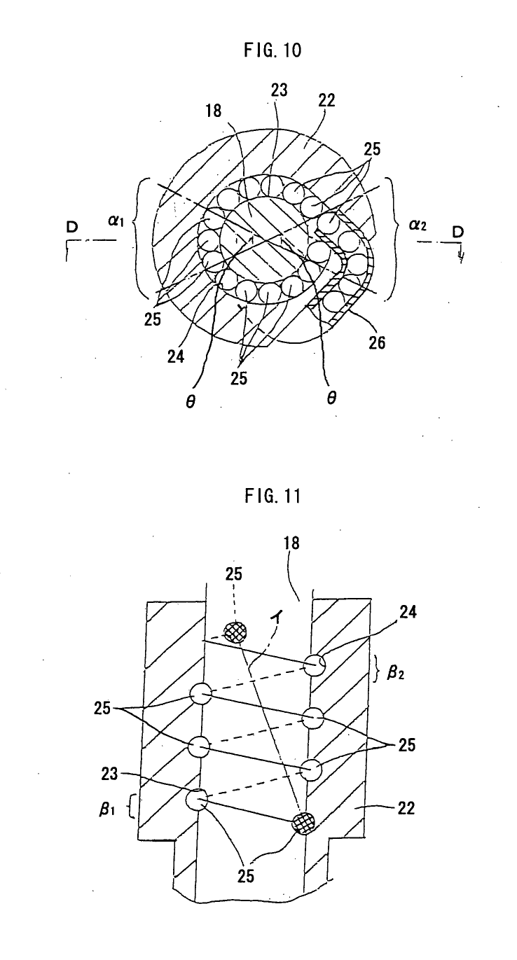

FIGS. 9 to 11 show a fourth embodiment. The drawings show a state where the position in which the drive arm 13 is mounted to the output member 27 is opposite to that in the first embodiment. The position of assembling the circulating tube 26 to the ball nut 22 is deviated by 135 degrees in the clockwise direction from that in the case of the first embodiment with respect to the circumferential direction of the ball nut 22. In this case, the direction of the moment M generated by engagement between the long hole 30 and the engagement pin 29 is opposite to that in FIG. 6. Therefore, the circulating tube 26 is disposed in the portion indicated by the chain line (a) in FIG. 11 with respective to the circumferential direction of the ball nut 22, and the openings at both ends of the circulating tube 26 exist in portions corresponding to the double-hatched balls 25 and 25 shown in FIG. 11. In such a case as well, the openings at both ends of the circulating tube 26 are disposed in portions off from the α1*β1 portion and the α2*β2 portion as the heavy load regions. Consequently, irrespective of the moment M applied to the ball nut 22, durability of the whole ball screw device can be improved.

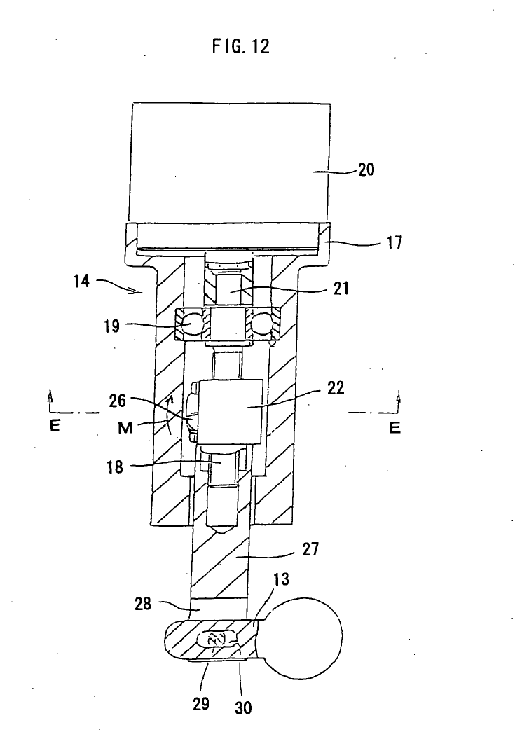

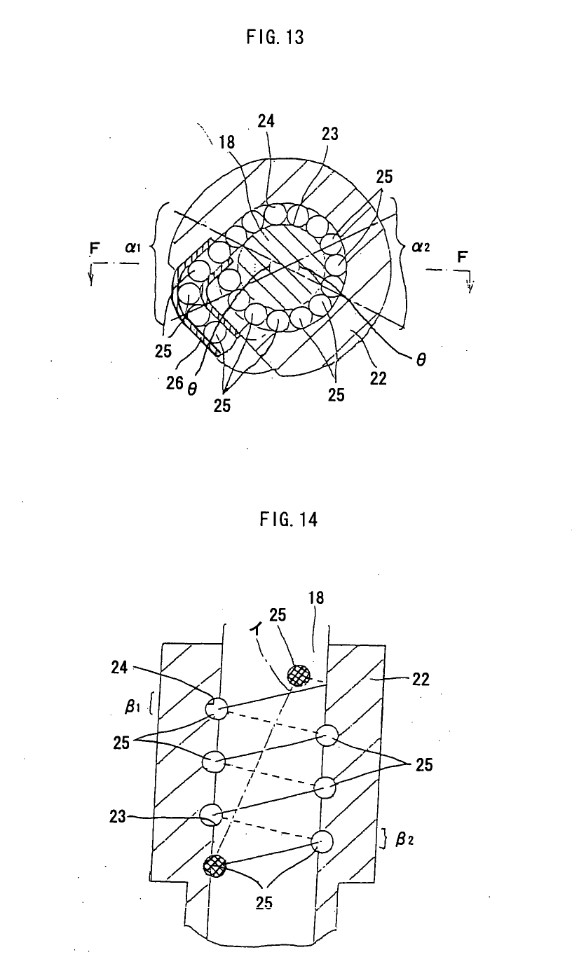

FIGS. 12 to 14 show a fifth embodiment and a state where the drive arm 13 to the output member 27 is disposed on the side opposite to that in the fourth embodiment. The position of assembling the circulating tube 26 to the ball nut 22 is deviated by 135 degrees in the counterclockwise direction from the case of the first embodiment with respect to the circulating direction of the ball nut 22. Therefore, the circulating tube 26 is disposed in the portion indicated by the chain line (a) of FIG. 14, and the openings at both ends of the circulating tube 26 exist in positions corresponding to the double-hatched balls 25 and 25 in FIG. 14. In this case as well, the openings at both ends of the circulating tube 26 are disposed off from the α1*β1 portion and the α2*β2 portion as the heavy load regions. Consequently, irrespective of the moment M applied to the ball nut 22, durability of the whole ball screw device can be improved.

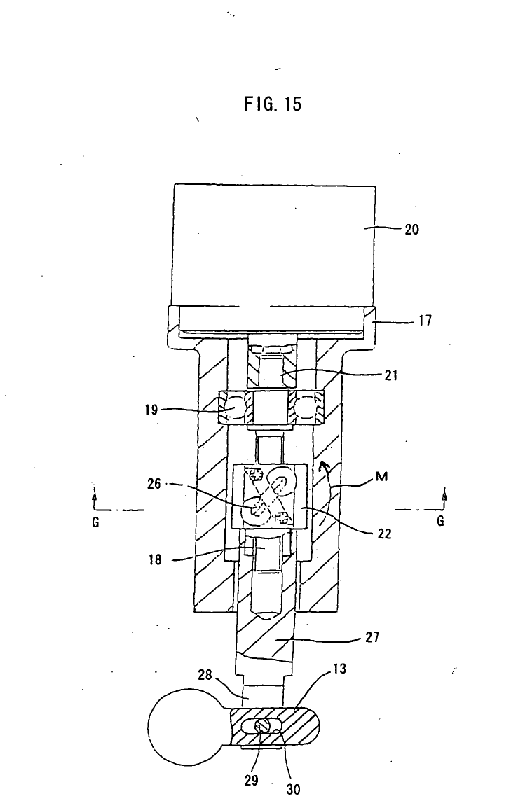

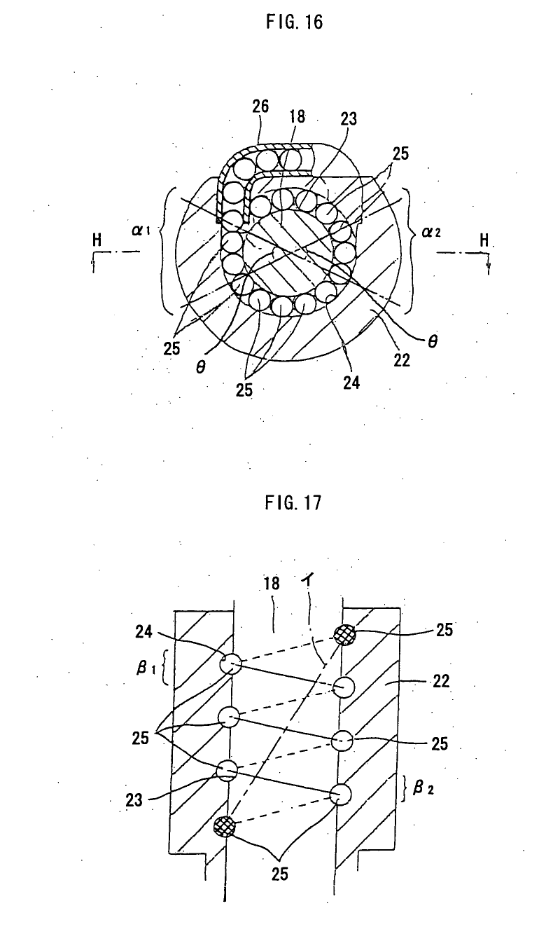

FIGS. 15 to 17 show a sixth embodiment and a state where the position of mounting the drive arm 13 to the output member 27 is on the side opposite to that in the first embodiment. The position of assembling the circulating tube 26 to the ball nut 22 is the same as that in the first embodiment with respect to the phase in the circumferential direction of the ball nut 22, but the disposing direction (the direction of inclination from the center axis) is opposite to that of the first embodiment. Therefore, in this case, the circulating tube 26 is disposed in the portion indicated by the chain line (a) of FIG. 17 and the openings at both ends of the circulating tube 26 exist in positions corresponding to the double-hatched balls 25 and 25 in FIG. 17. In this case as well, the openings at both ends of the circulating tube 26 are disposed off from the α1*β1 portion and the α2*β2 portion as the heavy load regions. Consequently, irrespective of the moment M applied to the ball nut 22, durability of the whole ball screw device can be improved.

The invention is constructed and acts as described above, so that uniform loads act on balls and the like with a simple configuration. As a result, rated fatigue life of a ball increases and the durability of the ball screw device improves. Excellent durability is assured in a case such that the invention is applied to an electric actuator for transmission of a vehicle, and reliability of an electric actuator can be improved.

In addition, the structure of the ball circulation passage is not limited to the circulating tube described in the above embodiments. Accordingly, various modifications such as circulation piece for circulating balls in the passage may be applied to the ball screw device of the invention.

1. A ball screw device comprising:
a ball screw shaft;
a ball nut which screws on the ball screw shaft; and
a plurality of balls rotatably provided in a spiral passage formed by an outer peripheral groove of the ball screw shaft and an inner peripheral groove of the ball nut,
rotational motion of a motor being converted to linear motion by sliding the ball screw shaft and the ball nut in the axial direction by relative rotation between the ball screw shaft and the ball nut,
wherein a contact surface is provided in an outer peripheral surface of the ball screw shaft and a contact surface is provided in an inner peripheral surface of the ball nut, which are in contact with each other.

2. The ball screw device according to claim 1, wherein the contact surfaces are provided at least at one of both ends of the spiral passage and provided as opposite surfaces of the outer peripheral surface of the ball screw shaft and the inner peripheral surface of the ball nut.

3. A ball screw device comprising:
a ball screw shaft;
a ball nut which screws on the ball screw shaft;
a plurality of balls rotatably provided in a spiral passage formed by an outer peripheral groove of the ball screw shaft and an inner peripheral groove of the ball nut; and
a circulating tube in which the balls moving in the spiral passage are circulated,
a contact surface being provided in an outer peripheral surface of the ball screw shaft and a contact surface being provided in an inner peripheral surface of the ball nut, which are in contact with each other, and
rotational motion of a motor being converted to linear motion by sliding the ball screw shaft and the ball nut in the axial direction by rotation of the ball screw shaft,
wherein openings at both ends of the circulating tube are disposed in positions which are not in regions of heavy loads among loads acting on a plurality of balls fit in the spiral passage, and the balls are transmitted/received in a connection position between the circulating tube and the spiral passage.

4. The ball screw device according to claim 3, wherein the contact surface is at least at one of both ends of the spiral passage and provided as opposite surfaces of the outer peripheral surface of the ball screw shaft and the inner peripheral surface of the ball nut.

5. The ball screw device according to any one of claims 1 to 4, wherein the contact surface is made of an intermediate member having a coefficient of friction lower than that of a ball screw shaft material and that of a ball nut material.

6. The ball screw device according to any one of claims 1 to 4, wherein the contact surface is made of an elastic member.

7. A ball screw device comprising:
a ball screw shaft;
a ball nut which screws on the ball screw shaft;
a plurality of balls rotatably provided in a spiral passage formed by an outer peripheral groove of the ball screw shaft and an inner peripheral groove of the ball nut; and
a circulating tube in which the balls moving in the spiral passage are circulated,
rotational motion of a motor being converted to linear motion by sliding the ball screw shaft and the ball nut in the axial direction by rotation of the ball screw shaft,
wherein openings at both ends of the circulating tube are disposed in positions which do not become regions of heavy loads among loads acting on a plurality of balls which are fit in the spiral passage, and the balls are transmitted/received in a connection position between the circulating tube and the spiral passage.
